(19) United States
(12) Patent Application Publication
(10) Pub. No.: US 2017/0151504 A1
(43) Pub. Date: Jun. 1, 2017

(54) PLUSH STUFFED ANIMAL WITH REMOVABLE RIGID TEETHING BANDANA

(71) Applicant: SKIP HOP, INC., New York, NY (US)

(72) Inventors: Janet VILLANO, Jersey City, NJ (US); Rany JOO, Hawthorne, NY (US); Benjamin BEARSCH, Brooklyn, NY (US); Ellen DIAMANT, New York, NY (US)

(21) Appl. No.: 14/955,840

(22) Filed: Dec. 1, 2015

(51) Int. Cl. A63H 3/00; A61J 17/00; A61J 17/02; A63H 3/02; A63H 3/28

(52) U.S. Cl. CPC A63H 3/003; A63H 3/02; A63H 3/28; A61J 17/02; A61J 17/007

(57) ABSTRACT

A plush toy is provided advantageously in the shape of an animal having a head, neck and torso. A separate, preferably removable, rigid teething member is disposed around the neck of the animal. In one advantageous form, the teething member is in the shape of a bandana.

### FIELD OF INVENTION

The present invention relates to toy with rigid teething member and in particular, in one form, a stuffed animal with removable rigid teething bandana for multi-sensory play.

### BACKGROUND OF THE INVENTION

Toys that stimulate and entertain infants include rattles, plastic teethers, squeakers, crinkle-sounding elements, mirrors and the like. These listed items can be included on mobiles infant playmat gyms, etc., which incorporate one or more of the aforementioned toys. In addition to include these infant toys as part of a collection (e.g. mobile or gym), stand-alone infant play toys such as teethers and rattles have been developed for infants. These items are provided for an infant while at home and while playing with the infant such as on the floor.

What is needed in the art is ever unique and different infant toys to entertain and stimulate the minds of an infant.

### SUMMARY OF THE INVENTION

The present invention relates to a toy with rigid teething member. In one form, the teething member is in the shape of a bandana which is removable from the toy such as a stuffed animal. The stuffed animal can be in the shape of any number of animals which includes but are not limited to a kitten, monkey, raccoon, fox, etc. Advantageously, the bandana is removable from stuffed animal and can be placed on the wrist of an infant. In various forms, the teething member provides for multi-sensory play and may for example include a plurality of raised protuberances or projections on its surface. The stuffed animal may include additional sensory items which includes but are not limited to a rattle, squeaker and crinkle elements which produce sound when touched.

The present invention, in one form, relates to a plush toy comprising a soft-sided material in the shape of an animal. The animal has a head, neck and torso. A separate rigid teething member is disposed around the neck of the animal. In one further form thereof, the teething member is removable from the animal and may optionally be placed on the wrist of an infant. In another advantageous form, the teething member is in the shape of a bandana. Further in another specific advantageous form, the bandana is composed of a rigid material such as a plastic material which is suitable for teething by an infant. Enhanced multi-sensory play can be provided by including a series or plurality of raised protuberances or projections extending outwards from a top surface of the teething member.

In yet another advantageous form, the teething member is in the shape of a ring having an accordion fold which provides flexibility to the teething member for being disposed around the neck of the animal and for placing on the wrist of an infant.

### BRIEF DESCRIPTION OF THE DRAWINGS

The present invention will now be described with regard to the drawings as follows.

FIG. 1 is a toy with removable teething member in accordance with the present invention.

FIG. 2 is another toy with teething member in accordance with the present invention.

FIG. 3 is yet another toy with teething member in accordance with the present invention.

FIG. 4 is still another toy with teething member in accordance with the present invention.

FIG. 5 is the teething member from FIGS. 1-4 shown removed from the toy, shown from above.

FIG. 6 is the teething member of FIG. 5, shown from below.

### DETAILED DESCRIPTION

The present invention will now be described with reference to the Figures. It will be appreciated that other toy designs and appearances are possible which are consistent with the described function of the present toy with rigid teething member.

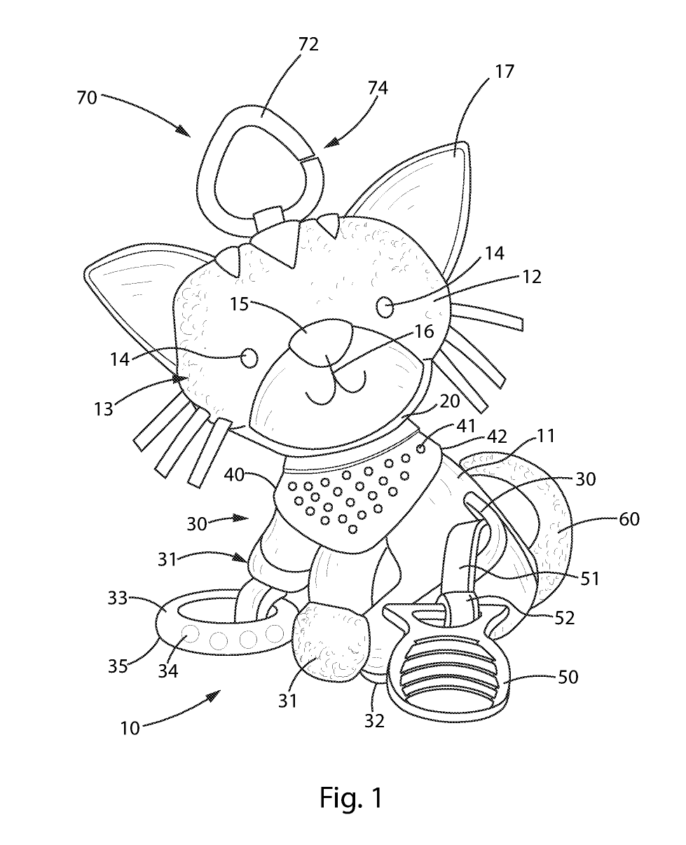

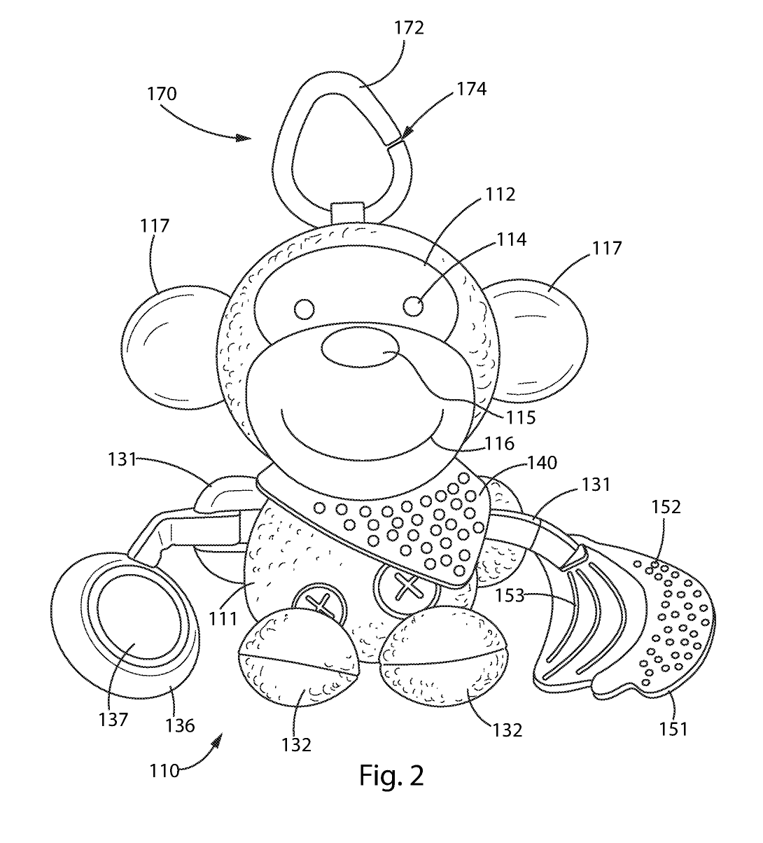

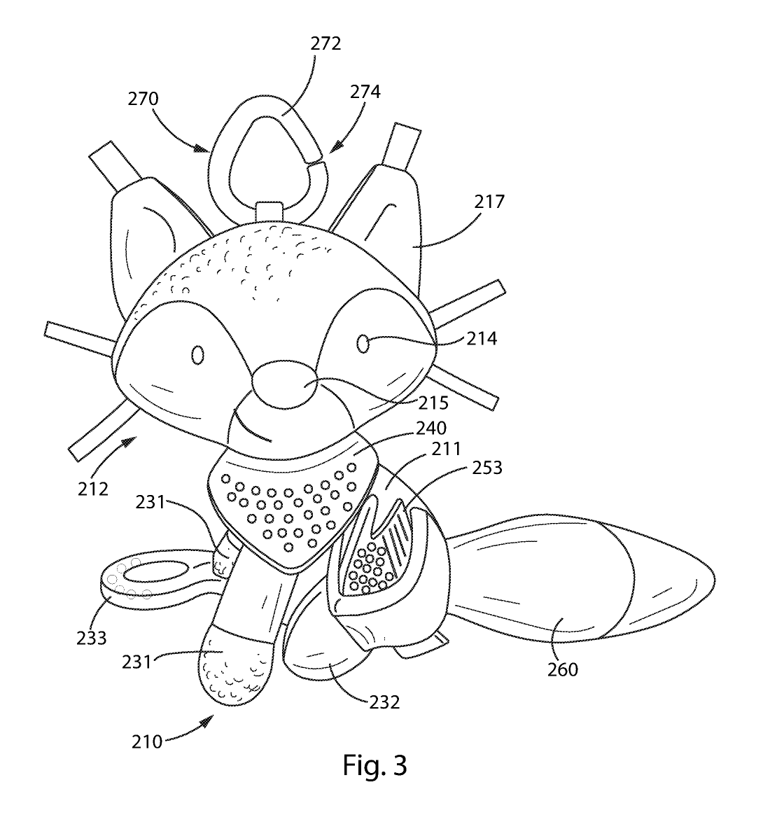

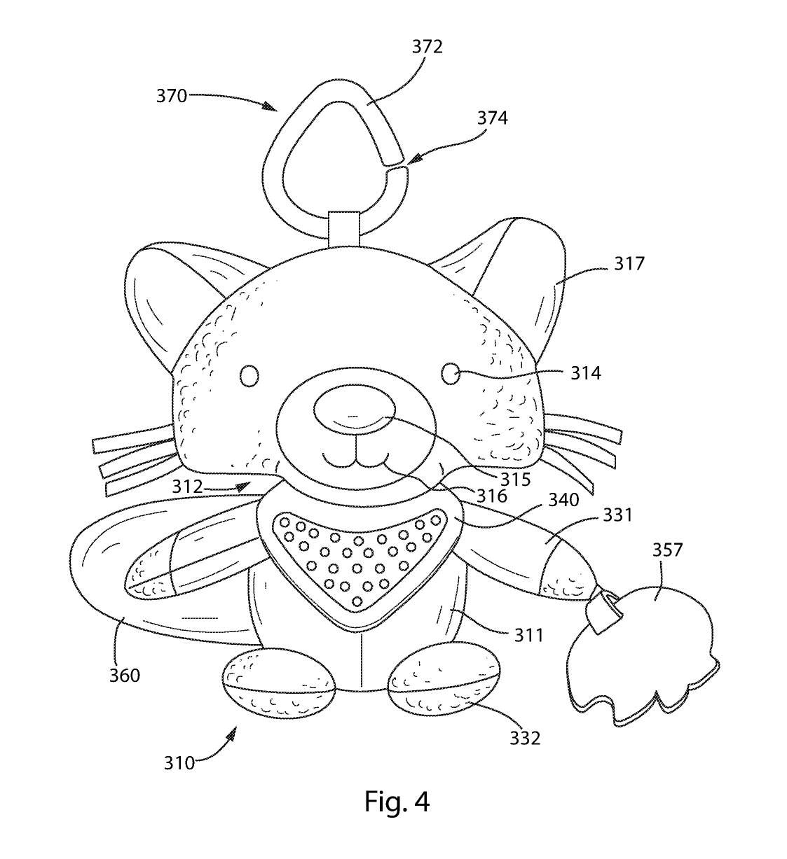

Referring specifically to FIGS. 1-4, the present toy can have the appearance of a stuffed animal such as a kitten 10 (FIG. 1), monkey 110 (FIG. 2), fox 210 (FIG. 3), and a raccoon 310 (FIG. 4). Kitten 10, monkey 110, fox 210 and raccoon 310 (collectively referred to as “toys”) are plush toys made of a soft sided material 11, 111, 211, 311 stuffed with a suitable compressible material such as polyester fill or cotton fill material. The toys have a head 12, 112, 212, 312; neck 20, 120, 220, 320 and torso 30, 130, 230, 330. A teething member in the shape of a bandana 40, 140, 240, 340 is disposed around the neck 20, 120, 220, 320. The bandana 40, 140, 240, 340 is removable from the neck 20, 120, 220, 320 and can be worn on the wrist of an infant. The bandana 40, 140, 240, 340 when disposed around the neck 20, 120, 220, 320 of toy 10, 110, 210, 310 can be rotated a complete 360° around the neck 20, 120, 220, 320.

Referring now specifically to kitten 10 (FIG. 1), kitten 10 has arms 31 and legs 32. Attached to one arm 31 is a rattle 33 having several balls 34 which freely move within a hollow ring 35. A second teething member 50 in the shape of a fish is attached to a strap 51 forming a loop 52 attached to the fish 50 on one end and the torso 30 on the other end. A tail 60 extends from the torso 30.

The kitten 10 has a face 13 with two eyes 14, a nose 15, mouth 16 and ears 17. The nose 15 includes a squeaker which produces noise when pressed. The ears 17 include a crinkle material such as wax paper covered with a fabric cover which produces a crinkling sound when touched.

A hanger 70 is attached to the head 20. The hanger 70 includes a main body 72 with a gap or break 74 which allows the hanger 70 to clamp onto a bar such as one of a stroller, playpen or crib.

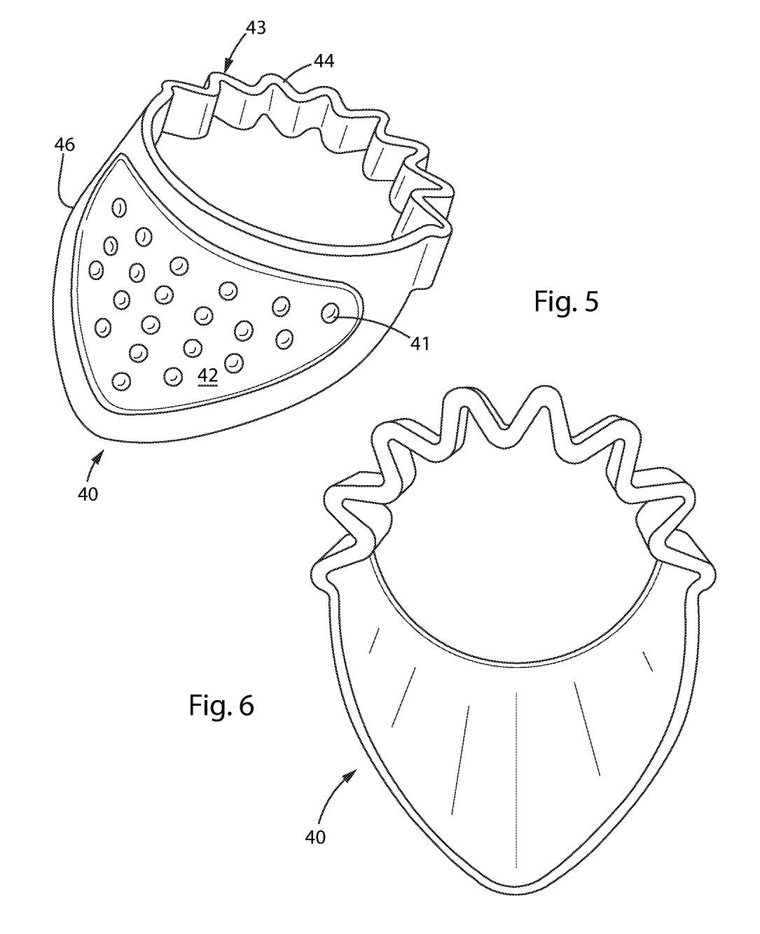

Referring now to FIG. 1 along with FIGS. 5 and 6, the bandana 40 has a plurality of protuberances or projections which extend upward from a top surface 42 of the bandana 40. The protuberances provide sensory play for an infant. The bandana 40 has a ring 43 shape composed of accordion folds 44 around one side and a substantially triangular shape portion 46 on a side opposite the accordion folds 44. The accordion folds 44 allow for stretchability and adjustability to the bandana ring 43, allowing the bandana 40 to be removed from the neck of the kitten 10 and for placement on an infant's wrist.

Referring now to FIG. 2, where like elements to those in FIG. 1 have been raised by 100, the present plush toy can be in the shape of monkey 110. Features which deviate from those of kitten 10 will be discussed with regard to monkey 110. A second teething member 151 in the form of a bunch of bananas are attached to an arm 131. The teething bananas 151 include a series of protuberances 152 as well as ridges 153 extending upward from a top surface of the teething member 151. In its other arm 131 is a rattle 136 with smooth surface 137.

Referring to FIG. 3, fox 210 has a second teething member 253. Like elements to those in kitten 10 have been raised by 200 in FIG. 3.

Raccoon 310 (FIG. 4) has like elements to those of kitten 10 (FIG. 1) raised by 300. A second teething member 357 is attached to one of its arms 331.

It will now be apparent to one of ordinary skill in the art that the present invention provided features and advantages not found in prior infant products. The present toy provides for multi-sensory play which includes a removable teething member advantageously in the shape of a bandana which can be worn by an infant. The present toy also includes additional multi-sensory elements which include a squeaker noise and crinkle ears, rattle, mirror and other elements for infant play.

One of ordinary skill in the art will recognize that additional embodiments are also possible without departing from the teachings of the presently-disclosed subject matter. This detailed description, and particularly the specific details of the exemplary embodiments disclosed herein, is given primarily for clarity of understanding, and no unnecessary limitations are to be understood therefrom, for modifications will become apparent to those skilled in the art upon reading this disclosure and can be made without departing from the spirit and scope of the presently-disclosed subject matter.

1. A plush toy comprising:
a soft-sided material in the shape of an animal, the animal having a head, neck and torso; and
a separate rigid teething member, disposed around the neck.

2. The plush toy of claim 1, wherein the teething member is in the shape of a bandana.

3. The plush toy of claim 2, wherein the shape is substantial triangular extending from a ring which surrounds the neck of the animal.

4. The plush toy of claim 1, wherein the teething member is composed of a plastic material.

5. The plush toy of claim 1, wherein the teething member has a plurality of raised protuberances extending upward from a top surface thereof

6. The plush toy of claim 3, wherein the ring is composed of accordion folds.

7. The plush toy of claim 1, wherein the animal has a face with two eyes, two ears, a nose and a mouth.

8. The plush toy of claim 1, wherein the animal has a face with a nose that produces a squeaking sound when depressed.

9. The plush toy of claim 7, wherein the animal further has two arms and two legs.

10. The plush toy of claim 1, wherein the teething member can rotate 360 degrees around the neck of the animal.

11. The plush toy of claim 1, wherein the animal is stuffed with a compressible material.

12. The plush toy of claim 11, wherein the compressible material is selected from the group consisting of polyester fill and cotton fill material.

13. The plush toy of claim 11, wherein a shape of the animal is selected from the group consisting of fox, raccoon, monkey, and cat.

14. The plush toy of claim 1, further comprising a second teething member.

15. The plush toy of claim 14, wherein the second teething member is attached to an arm of the animal.

16. The plush toy of claim 14, wherein the second teething member is in a shape selected from the group consisting of one or more bananas, fish,

17. The plush toy of claim 1, further comprising a rattle.

18. The plush toy of claim 17, wherein the rattle is attached to an arm of the animal.

19. The plush toy of claim 1, wherein the teething member is removable from the animal.

20. The plush toy of claim 19, wherein the teething member can be worn on a wrist of an infant.
